(19) United States
(12) Patent Application Publication
(10) Pub. No.: US 2025/0286143 A1
(43) Pub. Date: Sep. 11, 2025

(54) ELECTROLYTE SOLVENT FOR BATTERIES

(71) Applicant: Apple Inc., Cupertino, CA (US)

(72) Inventors: Andrew Basile, Santa Clara, CA (US); Bernd J. Neudecker, Los Gatos, CA (US)

(21) Appl. No.: 19/070,839

(22) Filed: Mar. 5, 2025

Related U.S. Application Data
(60) Provisional application No. 63/561,604, filed on Mar. 5, 2024.

(51) Int. Cl. H01M 10/0569; H01M 10/0567; H01M 10/0568

(52) U.S. Cl. CPC H01M 10/0569; H01M 10/0567; H01M 10/0568; H01M 2300/0034

(57) ABSTRACT

The disclosure is directed to a battery cell including halo-substituted alkyl electrolyte solvent compounds for use in battery cells such as lithium-ion (Li-ion) battery cells.

### PRIORITY

This patent application claims the benefit under 35 U.S.C. § 119(e) of U.S. Patent Application Ser. No. 63/561,604, entitled “ELECTROLYTE SOLVENT FOR BATTERIES”, filed on Mar. 5, 2024, which is incorporated herein by reference in its entirety.

### FIELD

This disclosure relates generally to battery cells, and more particularly, electrolyte solvents for use in battery cells, including lithium-ion (Li-ion) battery cells.

### BACKGROUND

Batteries, including Li-ion batteries, are widely used as the power sources in consumer electronics. Li-ion batteries include electrolyte fluids that typically are composed of an electrolyte salt dissolved in an electrolyte solvent, and optionally additives.

A battery life cycle can deteriorate at the cathode or anode. Typically, such solvent systems are stable at the cathode or anode, but not both. Conventional electrolyte solvents include oxygen moieties susceptible to degradation at the cathode. Previously attempts at using hydrocarbons as solvents were liquified gases exhibiting subzero boiling points, impractical for commercial battery use.

### SUMMARY

In a first aspect, the disclosure is directed to a battery cell. The battery cell can include a cathode having a cathode active material disposed on a cathode current collector, and an anode having an anode active material disposed on an anode current collector. The anode is oriented towards the cathode such that the anode active material faces the cathode active material. A separator is disposed between the cathode active material and the anode active material.

An electrolyte fluid is disposed between the cathode and anode. The electrolyte fluid includes a solvent compound having the structure according to Formula (I):

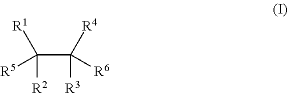

R¹ is selected from hydrogen, halo, alkyl, non-oxygen substituted alkyl, non-oxygen heteroalkyl, non-oxygen substituted non-oxygen heteroalkyl, halo-substituted alkyl, halo-substituted non-oxygen substituted alkyl, halo-substituted non-oxygen heteroalkyl, and non-oxygen substituted halo-substituted non-oxygen heteroalkyl;
R² is hydrogen or halo;
R³ is halo;
R⁴ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁵ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁶ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
or optionally R¹ and R⁴ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
or optionally R⁵ and R⁶ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
wherein if R² is hydrogen, then
R⁵ is halo, halo-substituted alkyl, non-oxygen substituted halo-substituted alkyl, halo-substituted non-oxygen heteroalkyl, non-oxygen substituted halo-substituted non-oxygen heteroalkyl, halo-substituted cycloalkyl, non-oxygen substituted halo-substituted cycloalkyl, or non-oxygen substituted non-oxygen heterocycloalkyl; or
R⁵ and R⁶ together with the carbon atoms to which they are attached form a halo-substituted cycloalkyl, non-oxygen substituted halo-substituted cycloalkyl, halo-substituted non-oxygen heterocycloalkyl, non-oxygen substituted halo-substituted non-oxygen heterocycloalkyl; and
the structure of Formula (I) has from 4 to 11 carbon atoms.

In other variations, if R² is hydrogen, then the halogen moiety of R⁵, or R⁵ and R⁶ together with the carbon atoms to which they are attached, is within two carbon atoms of the carbon to which R³ is attached.

In further variations,
R¹ is selected from hydrogen, alkyl, halo-substituted alkyl, and halo;
R² and R³ are each independently halo;
R⁴ is selected from hydrogen, alkyl, halo-substituted alkyl, and halo;
R⁵ is selected from hydrogen, alkyl, halo-substituted alkyl, and halo;
R⁶ is selected from hydrogen, alkyl, halo-substituted alkyl, and halo;
or optionally R¹ and R⁴ together with the carbon atoms to which they are attached form a C₄-C₉ cycloalkyl or halo-substituted C₄-C₉ cycloalkyl;
or optionally R⁵ and R⁶ together with the carbon atoms to which they are attached form a C₄-C₉ cycloalkyl or halo-substituted C₄-C₉ cycloalkyl; and
the structure of Formula (I) has from 4 to 11 carbon atoms.

In some variations, one or more of R¹, R⁴, R⁵, and R⁶ is a halo-substituted alkyl. In further variations, the halo-substitutions are fluoro-substitutions. In still further variations, the structure of Formula (I) has from 4 to 9 carbon atoms.

In a second aspect, the solvent compounds of Formula (I), the compound is an alkanyl solvent compound in which:
R¹ is selected from hydrogen, methyl, halo-substituted methyl, ethyl, halo-substituted ethyl, n-propyl, halo-substituted n-propyl, isopropyl, halo-substituted isopropyl, and halo;
R² and R³ are each independently halo;
R⁴ is selected from hydrogen, methyl, halo-substituted methyl, ethyl, halo-substituted ethyl, n-propyl, halo-substituted n-propyl, isopropyl, halo-substituted isopropyl, and halo;
R⁵ is selected from hydrogen, methyl, halo-substituted methyl, ethyl, halo-substituted ethyl, n-propyl, halo-substituted n-propyl, isopropyl, halo-substituted isopropyl, and halo; and
R⁶ is selected from hydrogen, methyl, halo-substituted methyl, ethyl, halo-substituted ethyl, n-propyl, halo-substituted n-propyl, isopropyl, halo-substituted isopropyl, and halo;
wherein the structure of Formula (I) has from 4 to 11 carbon atoms.

In one variation of the solvent compound, one or more of R¹, R⁴, R⁵, and R⁶ is selected from halo-substituted methyl, halo-substituted ethyl, halo-substituted n-propyl, and halo-substituted isopropyl. In another variation of the solvent compound, the halo-substitutions are fluoro-substitutions. In another variation, the solvent structure of Formula (I) has from 4 to 9 carbon atoms. In a further variation, the solvent compound is 2,3-difluorobutane (DFB).

In a third aspect, the solvent compound has the structure of Formula (IV):

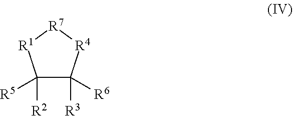

wherein
the ring including R¹—R⁷—R⁴ together with the carbon atoms to which they are attached form a C₄-C₉ cycloalkyl, halo-substituted C₄-C₉ cycloalkyl, non-oxygen substituted C₄-C₉ cycloalkyl, non-oxygen heterocycloalkyl, non-oxygen substituted non-oxygen heterocycloalkyl, non-oxygen substituted halo-substituted cycloalkyl, halo-substituted non-oxygen heterocycloalkyl, non-oxygen substituted halo-substituted non-oxygen heterocycloalkyl;
R² is hydrogen or halo;
R³ is halo;
R⁵ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁶ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
or optionally R⁵ and R⁶ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
wherein if R² is hydrogen, then

R⁵ is halo, halo-substituted alkyl, non-oxygen substituted halo-substituted alkyl, halo-substituted non-oxygen heteroalkyl, non-oxygen substituted halo-substituted non-oxygen heteroalkyl, halo-substituted cycloalkyl, non-oxygen substituted halo-substituted cycloalkyl, or non-oxygen substituted non-oxygen heterocycloalkyl; or

R⁵ and R⁶ together with the carbon atoms to which they are attached form a halo-substituted cycloalkyl, non-oxygen substituted halo-substituted cycloalkyl, halo-substituted non-oxygen heterocycloalkyl, non-oxygen substituted halo-substituted non-oxygen heterocycloalkyl; and
wherein the structure of Formula (IV) has from 4 to 11 carbon atoms.

In a further variation, the solvent compound has the structure of Formula (IV), the ring including R¹—R⁷—R⁴ together with the carbon atoms to which they are attached form a C₄-C₉ cycloalkyl or halo-substituted C₄
R¹ is selected from hydrogen, alkyl, halo-substituted alkyl;
R² and R³ are each independently halo;
R⁴ is selected from hydrogen, alkyl, halo-substituted alkyl;
R⁵ is selected from hydrogen, alkyl, halo-substituted alkyl, and halo;
R⁶ is selected from hydrogen, alkyl, halo-substituted alkyl, and halo;
or optionally R⁵ and R⁶ together with the carbon atoms to which they are attached form a C₄-C₆ cycloalkyl or halo-substituted C₄-C₆ cycloalkyl; and
wherein the structure of Formula (IV) has from 5 to 11 carbon atoms.

In one variation, the solvent compound is 1,2-difluorocyclohexane (DFCH). In another variation, the solvent compound is 1,2,4,5-tetrafluorocyclohexane (TFCH).

In further variations, the electrolyte solvent compound is from 30-95 wt % of the electrolyte fluid.

In further variations, the electrolyte fluid includes an electrolyte salt selected from LiPF₆, LiBF₄, LiClO₄, LiSO₃CF₃, LiN(SO₂F)₂ LiFSI, LiN(SO₂CF₃)₂, LiBC₄O₈, Li[PF₃(C₂CF₅)₃], LiC(SO₂CF₃)₃, lithium difluoro(oxalato)borate (LiDFOB), LiNO₃, LiI, lithium bis(oxalato)borate (LiBOB), and a combination thereof. In still further variations, the electrolyte salt has a concentration of 0.5 M to 4.0 M in the electrolyte fluid.

In some variations, the electrolyte fluid is consisting of the electrolyte solvent compound and an electrolyte salt.

In a fourth aspect, the disclosure is directed to a battery cell. The electrolyte fluid includes solvent selected from propylene carbonate (PC), ethylene carbonate (EC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), butyl acetate (BA), dimethoxyethane (DME), tetrahydrofuran (THF), 1,4-dioxane (DOX), 1,3-dioxane (DOL), a hydrofluoroether, and a combination thereof; and a cosolvent compound having the structure according to one of Formulae (I), (II), (IV), (V), (VI), (VII), (VIII), or (IX) (as described herein). In one variation, the cosolvent compound is from 5-50 wt % of the electrolyte fluid.

In a further variation, the electrolyte fluid includes an additive selected from lithium difluoro(oxalato)borate (LiDFOB), prop-1-ene-1, 3-sultone (PES), methylene methanedisulfonate (MMDS), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl)ether (EGPN), 1,3,6-hexanetricarbonitrile (HTCN), lithium iodide (LiI), Li(NO₃), LiBOB, and a combination thereof.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell in accordance with an illustrative embodiment; and

FIG. 2 is a perspective view of a battery cell in accordance with an illustrative embodiment.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

### Definitions

“Alkyl” refers to a saturated or unsaturated, branched, straight-chain or cyclic monovalent hydrocarbon radical derived by the removal of one hydrogen atom from a single carbon atom of a parent alkane, alkene or alkyne. Typical alkyl groups include, but are not limited to, methyl; ethyls such as ethanyl, ethenyl, ethynyl; propyls such as propan-1-yl, propan-2-yl, cyclopropan-1-yl, prop-1-en-1-yl, prop-1-en-2-yl, prop-2-en-1-yl (allyl), cycloprop-1-en-1-yl; cycloprop-2-en-1-yl, prop-1-yn-1-yl, prop-2-yn-1-yl, etc.; butyls such as butan-1-yl, butan-2-yl, 2-methyl-propan-1-yl, 2-methyl-propan-2-yl, cyclobutan-1-yl, but-1-en-1-yl, but-1-en-2-yl, 2-methyl-prop-1-en-1-yl, but-2-en-1-yl, but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, but-1-yn-1-yl, but-1-yn-3-yl, but-3-yn-1-yl, etc.; and the like.

The term “alkyl” is specifically intended to include groups having any degree or level of saturation, i.e., groups having exclusively single carbon-carbon bonds, groups having one or more double carbon-carbon bonds, groups having one or more triple carbon-carbon bonds and groups having mixtures of single, double and triple carbon-carbon bonds. Where a specific level of saturation is intended, the expressions “alkanyl”, alkenyl”, and alkynyl” are used. Preferably, an alkyl group comprises from 1 to 20 carbon atoms, more preferably, from 1 to 10 carbon atoms.

“Alkanyl” refers to a saturated branched, straight-chain or cyclic alkyl radical derived by the removal of one hydrogen atom from a single carbon atom of a parent alkane. Typical alkanyl groups include, but are not limited to, methanyl; ethanyl; propanyls such as propan-1-yl, propan-2-yl (isopropyl), cyclopropany-1-yl, etc.; butanyls such as butan-1-yl, butan-2-yl (sec-butyl), 2-methyl-propan-1-yl (isobutyl), 2-methyl-propan-2-yl (t-butyl), cyclobutan-1-yl, etc.; and the like.

“Alkenyl” refers to an unsaturated branched, straight-chain or cyclic alkyl radical having at least one carbon-carbon double bond derived by the removal of one hydrogen atom from a single carbon atom of a parent alkene. The group may be in either the cis or trans conformation about the double bond(s). Typical alkenyl groups include, but are not limited to, ethenyl; propenyls such as prop-1-en-1-yl, prop-1-en-2-yl, prop-2-en-1-yl (allyl), prop-2-en-2-yl, cycloprop-1-en-1-yl; cycloprop-2-en-1-yl; butenyls such as but-1-en-1-yl, but-1-en-2-yl, 2-methyl-prop-1-en-1-yl, but-2-en-1-yl, but-2-en-1-yl, but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, etc.; and the like.

“Alkynyl” refers to an unsaturated branched, straight-chain or cyclic alkyl radical having at least one carbon-carbon triple bond derived by the removal of one hydrogen atom from a single carbon atom of a parent alkyne. Typical alkynyl groups include, but are not limited to, ethynyl; propynyls such as prop-1-yn-1-yl, prop-2-yn-1-yl, etc.

“Cycloalkyl” refers to a saturated or unsaturated cyclic alkyl radical. Where a specific level of saturation is intended, the nomenclature “cycloalkanyl” or “cycloalkenyl” is used. Typical cycloalkyl groups include, but are not limited to, groups derived from cyclopropane, cyclobutane, cyclopentane, cyclohexane, and the like. In various aspects, the cycloalkyl group is (C₃-C₉) cycloalkyl, in some embodiments (C₃-C₇) cycloalkyl.

“Halo” means fluoro, chloro, bromo, or iodo.

“Halo-substituted alkyl” refers to an alkyl in which one or more carbons are substituted with halo substituent.

“Non-oxygen heteroalkyl”, “non-oxygen heteroalkanyl”, “non-oxygen heteroalkenyl”, and “non-oxygen eteroalkynyl” by themselves or as part of another substituent refer to alkyl, alkanyl, alkenyl, and alkynyl groups, respectively, in which one or more of the carbon atoms (and any associated hydrogen atoms) are independently replaced with the same or different non-oxygen heteroatomic groups, including but not limited to N, P, S, or Si. Heteroatomic groups which can be included in these groups include, but are not limited to, —S—, —S—S—, —NH—, —NH2, ═N—N═, —N═N—, and the like.

“Non-oxygen cycloheteroalkyl” by itself or as part of another substituent refers to a saturated or unsaturated cyclic alkyl radical in which one or more carbon atoms (and any associated hydrogen atoms) are independently replaced with the same or different heteroatom other than oxygen, including but not limited to N, P, S, or Si.

“Non-oxygen substituted” refers to a group in which one or more hydrogen atoms are independently replaced with the same or different substituent(s) containing no oxygen atoms.

“Substituted” refers to a group in which one or more hydrogen atoms are independently replaced with the same or different substituent(s).

### Battery Cells

The disclosure is directed to a class of halo-substituted alkane liquid electrolyte solvents that have improved stability over conventional solvents at the cathode at higher voltages, at the anode at lower voltages, and are also stable to Li metal.

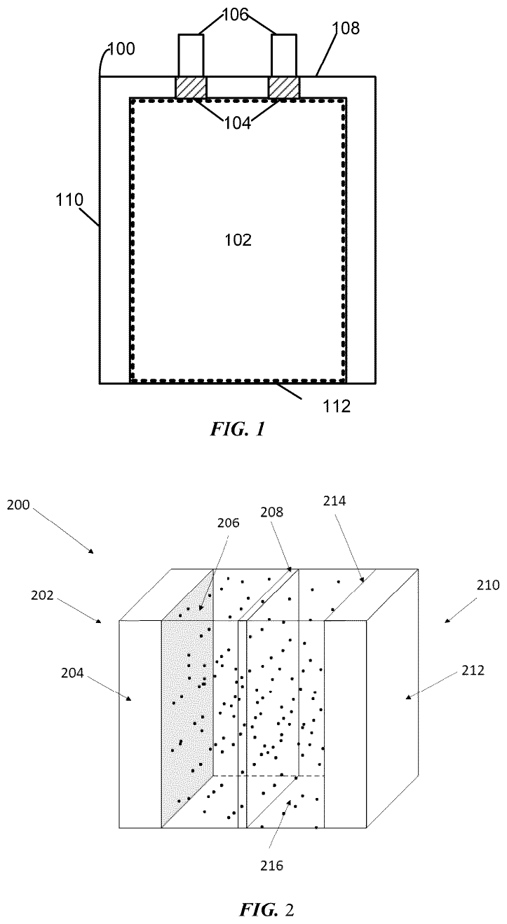

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode with a cathode active coating, a separator, and an anode with an anode active coating. More specifically, the stack 102 may include one strip of cathode active material (e.g., aluminum foil coated with a lithium compound) and one strip of anode active material (e.g., copper foil coated with carbon). The stack 102 also includes one strip of separator material (e.g., a microporous polymer membrane or non-woven fabric mat) disposed between the one strip of cathode active material and the one strip of anode active material. The cathode, anode, and separator layers may be left flat in a planar configuration or may be wrapped into a wound configuration (e.g., a “jelly roll”). An electrolyte solution is disposed between each cathode and anode.

During assembly of the battery cell 100, the stack 102 can be enclosed in a pouch or container. The stack 102 may be in a planar or wound configuration, although other configurations are possible. In some variations, the pouch such as a pouch formed by folding a flexible sheet along a fold line 112. In some instances, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack or may be embedded within an enclosure of a portable electronic device, such as a laptop computer, tablet computer, mobile phone, personal digital assistant (PDA), digital camera, and/or portable media player.

FIG. 2 presents a perspective view of battery cell 200 (e.g., the battery cell 100 of FIG. 1) in accordance with the disclosed embodiments. The battery includes a cathode 202 that includes current collector 204 and cathode active material 206 and anode 210 including anode current collector 212 and anode active material 214. Separator 208 is disposed between cathode 202 and anode 210. Electrolyte fluid 216 is disposed between cathode 202 and anode 210 and is in contact with separator 208. To create the battery cell, cathode 202, separator 208, and anode 210 may be stacked in a planar configuration, or stacked and then wrapped into a wound configuration. Electrolyte fluid 216 can then be added. Before assembly of the battery cell, the set of layers may correspond to a cell stack.

The cathode current collector, cathode active material, anode current collector, anode active material, and separator may be any material known in the art. In some variations, the cathode current collector may be an aluminum foil, the anode current collector may be a copper foil. The cathode active material can be any material described in, for example, Ser. Nos. 14/206,654, 15/458,604, 15/458,612, 15/709,961, 15/710,540, 15/804,186, 16/531,883, 16/529,545, 16/999,307, 16/999,328, 16/999,265, each of which is incorporated herein by reference in its entirety.

The separator may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (PVdF). However, other microporous polymer membranes or non-woven fabric mats are possible (e.g., gel polymer electrolytes).

In general, separators represent structures in a battery, such as interposed layers that prevent physical contact of cathodes and anodes while allowing ions to transport therebetween. Separators are formed of materials having pores that provide channels for ion transport, which may include absorbing an electrolyte fluid that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

### Electrolyte Fluids

In general, electrolyte fluid can act as a conductive pathway for the movement of cations passing from the negative to the positive electrodes during discharge. The electrolyte fluid includes an electrolyte salt, electrolyte solvent, and one or more optional electrolyte additives.

### Halo-Substituted Alkyl Electrolyte Solvents

The disclosure is directed to a class of halo-substituted alkane liquid electrolyte solvent compounds that has stability at the cathode at higher voltages, stability at lower anode lower voltages, and is stable to Li metal. In some variations, unlike conventional solvents, the halo-substituted alkane solvents of the disclosure can be in the form of a single solvent and single salt binary electrolyte system. In the binary system, the solvent is stable at both the cathode and anode.

In some variations, the solvent compounds are a single component system, including only one or more electrolyte salts. In other variations, the solvent compounds include additional components.

In one variation, the disclosure is directed to a solvent compound having the structure of Formula (I):

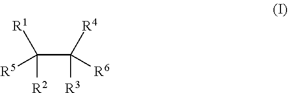

R¹ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R² is hydrogen or halo;
R³ is halo;
R⁴ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁵ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁶ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
or optionally R¹ and R⁴ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
or optionally R⁵ and R⁶ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
wherein if R² is hydrogen, then
R⁵ is halo, halo-substituted alkyl, non-oxygen substituted halo-substituted alkyl, halo-substituted non-oxygen heteroalkyl, non-oxygen substituted halo-substituted non-oxygen heteroalkyl, halo-substituted cycloalkyl, non-oxygen substituted halo-substituted cycloalkyl, or non-oxygen substituted non-oxygen heterocycloalkyl; or
R⁵ and R⁶ together with the carbon atoms to which they are attached form a halo-substituted cycloalkyl, non-oxygen substituted halo-substituted cycloalkyl, halo-substituted non-oxygen heterocycloalkyl, non-oxygen substituted halo-substituted non-oxygen heterocycloalkyl; and
the structure of Formula (I) has from 4 to 11 carbon atoms.

In further variations:
R¹ is selected from hydrogen, alkyl, halo-substituted alkyl, and halo;
R² and R³ are each independently halo;
R⁴ is selected from hydrogen, alkyl, halo-substituted alkyl, and halo;
R⁵ is selected from hydrogen, alkyl, halo-substituted alkyl, and halo;
R⁶ is selected from hydrogen, alkyl, halo-substituted alkyl, and halo;
or optionally R¹ and R⁴ together with the carbon atoms to which they are attached form a C₄-C₉ cycloalkyl or halo-substituted C₄-C₉ cycloalkyl;
or optionally R⁵ and R⁶ together with the carbon atoms to which they are attached form a C₄-C₉ cycloalkyl or halo-substituted C₄-C₉ cycloalkyl; and
the structure of Formula (I) has from 4 to 11 carbon atoms.

In some variations, the structure of Formula (IV) has less than or equal to 11 carbon atoms. In some variations, the structure of Formula (IV) has less than or equal to 10 carbon atoms. In some variations, the structure of Formula (IV) has less than or equal to 9 carbon atoms. In some variations, the structure of Formula (IV) has less than or equal to 8 carbon atoms. In some variations, the structure of Formula (IV) has less than or equal to 7 carbon atoms. In some variations, the structure of Formula (IV) has less than or equal to 6 carbon atoms. In some variations, the structure of Formula (IV) has less than or equal to 5 carbon atoms.

The compounds of Formula (I) are liquid, ranging from dihalo-substituted C4 to C11. The compounds of Formula (I) can be branched, unbranched, cyclic, etc., provided that at least two halo-substitutions are present. The compounds can by alkanyl, alkenyl, or alkynyl as defined herein.

The compounds of Formula (I) do not include oxygen atoms. When in an electrolyte fluid, oxygen atoms oxidize with lithium ion causing the solvent system to degrade. The solvent compounds of the disclosure do not include oxygen moieties, and therefore are not susceptible to such degradation. The compounds disclosed herein do not include oxygen moieties, thereby not coupling the promotion of salt and lithium dissolution at the expense of truncated oxidation stability at the cathode and resulting cathode degradation.

In variations, when R¹, R⁴, R⁵, and/or R⁶ are halo-substituted alkyl substituents, the halo-substitutions can be in pairs of halo-substitutions. That is, when R¹, R⁴, R⁵, and/or R⁶ is halo-substituted alkyl, the halo-substitution can include a halo-substitution on two adjacent carbon atoms, similar to that depicted for DFB below. The halo-substitutions can result in weak coordination with Li cations, also as depicted for DFB, below.

In still other variations, R² and R³ are each independently halo substituted. Each of R² and R³ can coordinate weakly with lithium anions.

In some variations, the halo-substitutions are fluoro-substitutions. In some variations, the halo-substitutions are chloro-substitutions. In some variations, the halo-substitutions are bromo-substitutions. In some variations, the halo-substitutions are iodo-substitutions. The halo-substitutions can be a combination of different halogens.

### Alkanyl Compounds

In some variations, the disclosure is directed to halo-substituted alkanyl compounds. In such variations, with further reference to the compound of Formula (I):
R¹ is selected from hydrogen, methyl, halo-substituted methyl, ethyl, halo-substituted ethyl, n-propyl, halo-substituted n-propyl, isopropyl, halo-substituted isopropyl, and halo;
R² and R³ are each independently halo;
R⁴ is selected from hydrogen, methyl, halo-substituted methyl, ethyl, halo-substituted ethyl, n-propyl, halo-substituted n-propyl, isopropyl, halo-substituted isopropyl, and halo;
R⁵ is selected from hydrogen, methyl, halo-substituted methyl, ethyl, halo-substituted ethyl, n-propyl, halo-substituted n-propyl, isopropyl, halo-substituted isopropyl, and halo; and
R⁶ is selected from hydrogen, methyl, halo-substituted methyl, ethyl, halo-substituted ethyl, n-propyl, halo-substituted n-propyl, isopropyl, halo-substituted isopropyl, and halo;
wherein the structure of Formula (I) has from 4 to 11 carbon atoms.

Alkyl substituents, including alkanes, are thermodynamically stable to lithium metal. At the cathode, oxygen-containing molecules can react with the cathode at high voltages, and therefore no oxygen substitutions are present.

Unlike previously reported hydrocarbons used as solvents, which formed liquified gases exhibiting subzero boiling points, the disclosed halo-substituted alkyl solvents are liquids at operational temperatures (e.g., room temperature 25° C. and higher).

The smallest, lowest substituted compound 2,3-difluorobutane (DFB) has a boiling point of 55° C. resulting from fluorine substitution, as depicted in the structure of Formula (II):

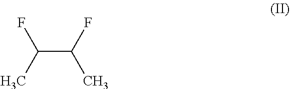

The disclosed solvent compounds result in improved solvent stability at both the anode and cathode, while also dissolving electrolyte salts. The electron-withdrawing halo-substituent can provide coordination sites to incorporate Li ion into solvation. For example, with reference to Formula (III), the fluoro-substituents positioned on adjoining carbon atoms in 2,3-difluorobutane provide electron-withdrawing coordination sites to incorporate Li+ cations into solvation.

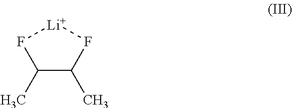

2,3-difluorobutane liquid dissolved a LiFSI salt to concentration of less than 5 mol %, preparing a colored solution proving concept for hydrofluorocarbon-based electrolyte systems. Introducing two fluorine atoms at adjacent carbon positions can permit a stable 5-member ring coordination site with a Li⁺ ion, while also providing a liquid increasing the resulting material's boiling point to above 50° C.

The compounds are not limited to straight chain halo-substituted structures. Halo-substituted cycloalkyl compounds are provided. With reference to the compounds of Formula (I), the solvent compounds can have the structure of Formula (IV):

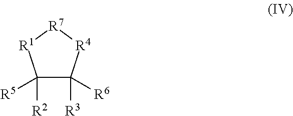

wherein
the ring including R¹—R⁷—R⁴ together with the carbon atoms to which they are attached form a C₄-C₉ cycloalkyl, halo-substituted C₄-C₉ cycloalkyl, non-oxygen substituted C₄-C₉ cycloalkyl, non-oxygen heterocycloalkyl, non-oxygen substituted non-oxygen heterocycloalkyl, non-oxygen substituted halo-substituted cycloalkyl, halo-substituted non-oxygen heterocycloalkyl, non-oxygen substituted halo-substituted non-oxygen heterocycloalkyl;
R² is hydrogen or halo;
R³ is halo;
R⁵ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁶ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
or optionally R⁵ and R⁶ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
wherein if R² is hydrogen, then
R⁵ is halo, halo-substituted alkyl, non-oxygen substituted halo-substituted alkyl, halo-substituted non-oxygen heteroalkyl, non-oxygen substituted halo-substituted non-oxygen heteroalkyl, halo-substituted cycloalkyl, non-oxygen substituted halo-substituted cycloalkyl, or non-oxygen substituted non-oxygen heterocycloalkyl; or
R⁵ and R⁶ together with the carbon atoms to which they are attached form a halo-substituted cycloalkyl, non-oxygen substituted halo-substituted cycloalkyl, halo-substituted non-oxygen heterocycloalkyl, non-oxygen substituted halo-substituted non-oxygen heterocycloalkyl; and
wherein the structure of Formula (IV) has from 4 to 11 carbon atoms.

In some variations, the ring including R¹—R⁷—R⁴ together with the carbon atoms to which they are attached form a C₄-C₉ cycloalkyl or halo-substituted C₄-C₉ cycloalkyl;
R¹ is selected from hydrogen, alkyl, halo-substituted alkyl;
R² and R³ are each independently halo;
R⁴ is selected from hydrogen, alkyl, halo-substituted alkyl;
R⁵ is selected from hydrogen, alkyl, halo-substituted alkyl, and halo;
R⁶ is selected from hydrogen, alkyl, halo-substituted alkyl, and halo;
or optionally R⁵ and R⁶ together with the carbon atoms to which they are attached form a C₄-C₆ cycloalkyl or halo-substituted C₄-C₆ cycloalkyl; and
wherein the structure of Formula (IV) has from 5 to 11 carbon atoms.

In some variations, the structure of Formula (IV) has at least 5 carbon atoms. In some variations, the structure of Formula (IV) has at least 6 carbon atoms. In some variations, the structure of Formula (IV) has at least 7 carbon atoms. In some variations, the structure of Formula (IV) has at least 8 carbon atoms. In some variations, the structure of Formula (IV) has at least 9 carbon atoms. In some variations, the structure of Formula (IV) has at least 10 carbon atoms.

In some variations, the structure of Formula (IV) has less than or equal to 11 carbon atoms. In some variations, the structure of Formula (IV) has less than or equal to 10 carbon atoms. In some variations, the structure of Formula (IV) has less than or equal to 9 carbon atoms. In some variations, the structure of Formula (IV) has less than or equal to 8 carbon atoms. In some variations, the structure of Formula (IV) has less than or equal to 7 carbon atoms. In some variations, the structure of Formula (IV) has less than or equal to 6 carbon atoms.

In some variations, the ring defined by R¹—R⁷—R⁴ together with the carbon atoms to which they are attached form a di-halo-substituted C₄-C₉ cycloalkyl in which two adjacent carbons are each halo-substituted. Any halo-substitution as described herein can be used. In some variations, the halo-substitution can be a fluoro-substituent. In further aspects, the ring defined by R¹—R⁷—R⁴ together with the carbon atoms to which they are attached form a di-halo-substituted C₄-C₉ cycloalkanyl structure in which two adjacent carbons are each halo-substituted.

In some variations, the compound of Formula (IV) is an alkanyl structure. In such structures:
the ring including R¹—R⁷—R⁴ together with the carbon atoms to which they are attached form a C₄-C₉ cycloalkanyl or halo-substituted C₄-C₉ cycloalkanyl;
R² and R³ are each independently halo;
R⁵ is selected from hydrogen, methyl, halo-substituted methyl, ethyl, halo-substituted ethyl, n-propyl, halo-substituted n-propyl, isopropyl, halo-substituted isopropyl, and halo;
R⁶ is selected from hydrogen, methyl, halo-substituted methyl, ethyl, halo-substituted ethyl, n-propyl, halo-substituted n-propyl, isopropyl, halo-substituted isopropyl, and halo;
wherein the structure of Formula (IV) has from 4 to 11 carbon atoms.

Several specific hydrocarbons of different lengths and structure, having varying degree of fluorination in vicinal positions, show solvent capability for a lithium salt (LiFSI). The example variations can include open and closed hexane chains with and without a vicinal di-fluoro functionality, and can include heptane and octane length chains with and without a tetra-fluoro functionality (i.e., two separated vicinal fluorine nests.)

In one example, the compound can be 1,2-difluorocyclohexane (DFCH) (Formula (V)). The cyclic structure provides lesser degrees of freedom for C—F bonding rotation which in some instances provide a stable coordination site for the Li⁺ ion.

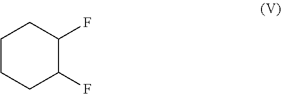

Additional adjacent halogen substitution in a cycloalkyl structure be used to induce an increase in the solubility limit of salts within the HFC class of material. Additional halo-substitution pairs on adjacent carbons of longer halo-substituted alkanes can provide additional solvation sites.

In one such example, the compound can be 1,2,4,5-tetrafluorocyclohexane (TFCH) (Formula (VI)). TFCH provides two Li⁺ ion 5-member ring sites coordinated by two pairs of fluoro-substitutions, while DFC provides only one.

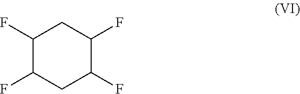

In another example, the compound can be 1,2-difluorohexane (DFH) (Formula (VII)).

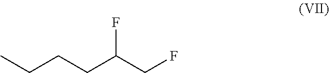

In another example, the compound can be 1,2,6,7-tetrafluoroheptane (TFG) (Formula (VIII)).

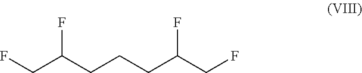 [SMILES: FCC(F)CCCC(F)CF]

In another example, the compound can be 1,2,7,8-tetrafluoro-octane (TFO) (Formula (IX)).

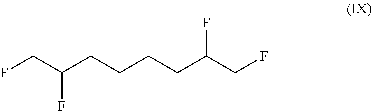 [SMILES: FCC(F)CCCCC(F)CF]

If used as a solvent, in some variations, the solvent of compound Formulae (I), (II), (IV), (V), (VI), (VII), (VIII), or (IX) can be an amount of at least 30 wt %. In some variations, the solvent of compound Formulae (I), (II), (IV), (V), (VI), (VII), (VIII), or (IX) can be an amount of at least 40 wt %. In some variations, the solvent of compound Formulae (I), (II), (IV), (V), (VI), (VII), (VIII), or (IX) can be an amount of at least 50 wt %. In some variations, the solvent of compound Formulae (I), (II), (IV), (V), (VI), (VII), (VIII), or (IX) can be an amount of at least 60 wt %. In some variations, the solvent of compound Formulae (I), (II), (IV), (V), (VI), (VII), (VIII), or (IX) can be an amount of at least 70 wt %. In some variations, the solvent of compound Formulae (I), (II), (IV), (V), (VI), (VII), (VIII), or (IX) can be an amount of at least 80 wt %. In some variations, the solvent of compound Formulae (I), (II), (IV), (V), (VI), (VII), (VIII), or (IX) can be an amount of at least 90 wt %. In some variations, the solvent of compound Formulae (I), (II), (IV), (V), (VI), (VII), (VIII), or (IX) can be less than or equal to 95 wt %. In some variations, the solvent of compound Formulae (I), (II), (IV), (V), (VI), (VII), (VIII), or (IX) can be less than or equal to 90 wt %. In some variations, the solvent of compound Formulae (I), (II), (IV), (V), (VI), (VII), (VIII), or (IX) can be less than or equal to 80 wt %. In some variations, the solvent of compound Formulae (I), (II), (IV), (V), (VI), (VII), (VIII), or (IX) can be less than or equal to 70 wt %. In some variations, the solvent of compound Formulae (I), (II), (IV), (V), (VI), (VII), (VIII), or (IX) can be less than or equal to 60 wt %. In some variations, the solvent of compound Formulae (I), (II), (IV), (V), (VI), (VII), (VIII), or (IX) can be less than or equal to 50 wt %. In some variations, the solvent of compound Formulae (I), (II), (IV), (V), (VI), (VII), (VIII), or (IX) can be less than or equal to 40 wt %.

The amount of solvent can be selected from the lower boundary, higher boundary, or combination of both lower and higher boundary, in any combination described herein.

### Cosolvents

In some variations, the compound of Formula (I) can be used as a co-solvent.

The electrolyte solvent described herein can be a co-solvent. The additional solvent may be any type of electrolyte solvent suitable for battery cells. Non-limiting examples of the electrolyte solvents include propylene carbonate (PC), ethylene carbonate (EC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), butyl acetate (BA), dimethoxyethane (DME), tetrahydrofuran (THF), 1,4-dioxane (DOX), 1,3-dioxane (DOL), a hydrofluoroether, or combinations thereof.

If used as a cosolvent, in some variations, the cosolvent of compound Formulae (I), (II), (IV), (V), (VI), (VII), (VIII), or (IX) can be an amount of at least 5 wt %. In some variations, the cosolvent of compound Formulae (I), (II), (IV), (V), (VI), (VII), (VIII), or (IX) can be an amount of at least 10 wt %. In some variations, the cosolvent of compound Formulae (I), (II), (IV), (V), (VI), (VII), (VIII), or (IX) can be an amount of at least 20 wt %. In some variations, the cosolvent of compound Formulae (I), (II), (IV), (V), (VI), (VII), (VIII), or (IX) can be an amount of at least 30 wt %. In some variations, the cosolvent of compound Formulae (I), (II), (IV), (V), (VI), (VII), (VIII), or (IX) can be an amount of at least 40 wt %. In some variations, the cosolvent of compound Formulae (I), (II), (IV), (V), (VI), (VII), (VIII), or (IX) can be less than or equal to 50 wt %. In some variations, the cosolvent of compound Formulae (I), (II), (IV), (V), (VI), (VII), (VIII), or (IX) can be less than or equal to 40 wt %. In some variations, the cosolvent of compound Formulae (I), (II), (IV), (V), (VI), (VII), (VIII), or (IX) can be less than or equal to 30 wt %. In some variations, the cosolvent of compound Formulae (I), (II), (IV), (V), (VI), (VII), (VIII), or (IX) can be less than or equal to 20 wt %. In some variations, the cosolvent of compound Formulae (I), (II), (IV), (V), (VI), (VII), (VIII), or (DC) can be less than or equal to 10 wt %.

The amount of cosolvent can be selected from the lower boundary, higher boundary, or combination of both lower and higher boundary, in any combination described herein.

### Electrolyte Salts

The electrolyte fluid also has one or more electrolyte salts dissolved therein. The salt may be any type of salt suitable for battery cells. For example, and without limitation, salts for a lithium-ion battery cell include LiPF₆, LiBF₄, LiClO₄, LiSO₃CF₃, LiFSI, LiN(SO₂CF₃)₂, LiBC₄O₈, Li[PF₃(C₂CF₅)₃], LiC(SO₂CF₃)₃, LiDFOB, LiNO₃, LiI, LiBOB, and a combination thereof. Other salts are possible, including combinations of salts.

In some variations, the salt is at least 0.1 M in the total electrolyte fluid. In some variations, the salt is at least 0.5 M in the total electrolyte fluid. In some variations, the salt is at least 1.0 M in the total electrolyte fluid. In some variations, the salt is at least 1.5 M in the total electrolyte fluid. In some variations, the salt is at least 2.0 M in the total electrolyte fluid. In some variations, the salt is at least 2.5 M in the total electrolyte fluid. In some variations, the salt is at least 3.0 M in the total electrolyte fluid. In some variations, the salt is at least 3.5 M in the total electrolyte fluid.

In some variations, the salt is less than or equal to 4.0 M in the electrolyte fluid. In some variations, the salt is less than or equal to 3.5 M in the electrolyte fluid. In some variations, the salt is less than or equal to 3.0 M in the electrolyte fluid. In some variations, the salt is less than or equal to 2.5 M in the electrolyte fluid. In some variations, the salt is less than or equal to 2.0 M in the electrolyte fluid. In some variations, the salt is less than or equal to 1.5 M in the electrolyte fluid. In some variations, the salt is less than or equal to 1.0 M in the electrolyte fluid. In some variations, the salt is less than or equal to 0.5 M in the electrolyte fluid.

### Electrolyte Additives

In some variations, the total additives are less than or equal to 0.5 wt % of the electrolyte fluid.

In some variations, the electrolyte fluid can include one or more additives. In various aspects, the additives can include lithium difluoro(oxalato)borate (LiDFOB), prop-1-ene-1, 3-sultone (PES), methylene methanedisulfonate (MMDS), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl)ether (EGPN), 1,3,6-hexanetricarbonitrile (HTCN), lithium iodide (LiI), Li(NO₃), LiBOB, and a combination thereof in amount or range of quantities.

In some variations, LiDFOB is at least 0.1 wt % of the total electrolyte fluid. In some variations, LiDFOB is at least 0.2 wt % of the total electrolyte fluid. In some variations, LiDFOB is at least 0.3 wt % of the total electrolyte fluid. In some variations, LiDFOB is at least 0.4 wt % of the total electrolyte fluid. In some variations, LiDFOB is at least 0.5 wt % of the total electrolyte fluid. In some variations, LiDFOB is at least 0.6 wt % of the total electrolyte fluid. In some variations, LiDFOB is at least 0.7 wt % of the total electrolyte fluid. In some variations, LiDFOB is at least 0.8 wt % of the total electrolyte fluid. In some variations, LiDFOB is at least 0.9 wt % of the total electrolyte fluid. In some variations, LiDFOB is at least 1.0 wt % of the total electrolyte fluid. In some variations, LiDFOB is at least 1.3 wt % of the total electrolyte fluid. In some variations, LiDFOB is at least 1.6 wt % of the total electrolyte fluid. In some variations, LiDFOB is at least 1.9 wt % of the total electrolyte fluid.

In some variations, LiDFOB is less than or equal to 2.0 wt % of the total electrolyte fluid. In some variations, LiDFOB is less than or equal to 1.9 wt % of the total electrolyte fluid. In some variations, LiDFOB is less than or equal to 1.3 wt % of the total electrolyte fluid. In some variations, LiDFOB is less than or equal to 1.2 wt % of the total electrolyte fluid. In some variations, LiDFOB is less than or equal to 1.1 wt % of the total electrolyte fluid. In some variations, LiDFOB is less than or equal to 1.0 wt % of the total electrolyte fluid. In some variations, LiDFOB is less than or equal to 0.9 wt % of the total electrolyte fluid. In some variations, LiDFOB is less than or equal to 0.8 wt % of the total electrolyte fluid. In some variations, LiDFOB is less than or equal to 0.7 wt % of the total electrolyte fluid. In some variations, LiDFOB is less than or equal to 0.6 wt % of the total electrolyte fluid. In some variations, LiDFOB is less than or equal to 0.5 wt % of the total electrolyte fluid. In some variations, LiDFOB is less than or equal to 0.4 wt % of the total electrolyte fluid. In some variations, LiDFOB is less than or equal to 0.3 wt % of the total electrolyte fluid. In some variations, LiDFOB is less than or equal to 0.2 wt % of the total electrolyte fluid.

The amount of LiDFOB can be selected from the lower boundary, higher boundary, or combination of both lower and higher boundary, in any combination described herein.

In some variations, the amount of PES is at least 0.5 wt % of the total electrolyte fluid. In some variations, the amount of PES is at least 0.6 wt % of the total electrolyte fluid. In some variations, the amount of PES is at least 0.9 wt % of the total electrolyte fluid. In some variations, the amount of PES is at least 1.3 wt % of the total electrolyte fluid. In some variations, the amount of PES is at least 1.6 wt % of the total electrolyte fluid. In some variations, the amount of PES is at least 1.9 wt % of the total electrolyte fluid. In some variations, the amount of PES is at least 2.2 wt % of the total electrolyte fluid. In some variations, the amount of PES is at least 2.5 wt % of the total electrolyte fluid. In some variations, the amount of PES is at least 2.8 wt % of the total electrolyte fluid. In some variations, the amount of PES is at least 3.1 wt % of the total electrolyte fluid.

In some variations, the amount of PES is less than or equal to 3.5 wt % of the total electrolyte fluid. In some variations, the amount of PES is less than or equal to 3.1 wt % of the total electrolyte fluid. In some variations, the amount of PES is less than or equal to 2.8 wt % of the total electrolyte fluid. In some variations, the amount of PES is less than or equal to 2.5 wt % of the total electrolyte fluid. In some variations, the amount of PES is less than or equal to 2.2 wt % of the total electrolyte fluid. In some variations, the amount of PES is less than or equal to 1.9 wt % of the total electrolyte fluid. In some variations, the amount of PES is less than or equal to 1.6 wt % of the total electrolyte fluid. In some variations, the amount of PES is less than or equal to 1.3 wt % of the total electrolyte fluid. In some variations, the amount of PES is less than or equal to 1.1 wt % of the total electrolyte fluid. In some variations, the amount of PES is less than or equal to 0.9 wt % of the total electrolyte fluid. In some variations, the amount of PES is less than or equal to 0.6 wt % of the total electrolyte fluid.

The amount of PES can be selected from the lower boundary, higher boundary, or combination of both lower and higher boundary, in any combination described herein.

In some variations, the amount of MMDS is at least 0.1 wt % of the total electrolyte fluid. In some variations, the amount of MMDS is at least 0.2 wt % of the total electrolyte fluid. In some variations, the amount of MMDS is at least 0.3 wt % of the total electrolyte fluid. In some variations, the amount of MMDS is at least 0.4 wt % of the total electrolyte fluid. In some variations, the amount of MMDS is at least 0.5 wt % of the total electrolyte fluid. In some variations, the amount of MMDS is at least 0.6 wt % of the total electrolyte fluid. In some variations, the amount of MMDS is at least 0.7 wt % of the total electrolyte fluid. In some variations, the amount of MMDS is at least 0.8 wt % of the total electrolyte fluid. In some variations, the amount of MMDS is at least 0.9 wt % of the total electrolyte fluid. In some variations, the amount of MMDS is at least 1.0 wt % of the total electrolyte fluid. In some variations, the amount of MMDS is at least 1.1 wt % of the total electrolyte fluid. In some variations, the amount of MMDS is at least 1.2 wt % of the total electrolyte fluid. In some variations, the amount of MMDS is at least 1.3 wt % of the total electrolyte fluid. In some variations, the amount of MMDS is at least 1.4 wt % of the total electrolyte fluid.

In some variations, the amount of MMDS is less than or equal to 1.5 wt % of the total electrolyte fluid. In some variations, the amount of MMDS is less than or equal to 1.4 wt % of the total electrolyte fluid. In some variations, the amount of MMDS is less than or equal to 1.3 wt % of the total electrolyte fluid. In some variations, the amount of MMDS is less than or equal to 1.2 wt % of the total electrolyte fluid. In some variations, the amount of MMDS is less than or equal to 1.1 wt % of the total electrolyte fluid. In some variations, the amount of MMDS is less than or equal to 1.0 wt % of the total electrolyte fluid. In some variations, the amount of MMDS is less than or equal to 0.9 wt % of the total electrolyte fluid. In some variations, the amount of MMDS is less than or equal to 0.8 wt % of the total electrolyte fluid. In some variations, the amount of MMDS is less than or equal to 0.7 wt % of the total electrolyte fluid. In some variations, the amount of MMDS is less than or equal to 0.6 wt % of the total electrolyte fluid. In some variations, the amount of MMDS is less than or equal to 0.5 wt % of the total electrolyte fluid. In some variations, the amount of MMDS is less than or equal to 0.4 wt % of the total electrolyte fluid. In some variations, the amount of MMDS is less than or equal to 0.3 wt % of the total electrolyte fluid. In some variations, the amount of MMDS is less than or equal to 0.2 wt % of the total electrolyte fluid.

The amount of MMDS can be selected from the lower boundary, higher boundary, or combination of both lower and higher boundary, in any combination described herein.

In some variations, the amount of VEC is at least 0.1 wt % of the total electrolyte fluid. In some variations, the amount of VEC is at least 0.2 wt % of the total electrolyte fluid. In some variations, the amount of VEC is at least 0.3 wt % of the total electrolyte fluid. In some variations, the amount of VEC is at least 0.4 wt % of the total electrolyte fluid. In some variations, the amount of VEC is at least 0.5 wt % of the total electrolyte fluid. In some variations, the amount of VEC is at least 0.6 wt % of the total electrolyte fluid. In some variations, the amount of VEC is at least 0.7 wt % of the total electrolyte fluid. In some variations, the amount of VEC is at least 0.8 wt % of the total electrolyte fluid. In some variations, the amount of VEC is at least 0.9 wt % of the total electrolyte fluid.

In some variations, the amount of VEC is less than or equal to 1.0 wt % of the total electrolyte fluid. In some variations, the amount of VEC is less than or equal to 0.9 wt % of the total electrolyte fluid. In some variations, the amount of VEC is less than or equal to 0.8 wt % of the total electrolyte fluid. In some variations, the amount of VEC is less than or equal to 0.7 wt % of the total electrolyte fluid. In some variations, the amount of VEC is less than or equal to 0.6 wt % of the total electrolyte fluid. In some variations, the amount of VEC is less than or equal to 0.5 wt % of the total electrolyte fluid. In some variations, the amount of VEC is less than or equal to 0.4 wt % of the total electrolyte fluid. In some variations, the amount of VEC is less than or equal to 0.3 wt % of the total electrolyte fluid. In some variations, the amount of VEC is less than or equal to 0.2 wt % of the total electrolyte fluid.

The amount of VEC can be selected from the lower boundary, higher boundary, or combination of both lower and higher boundary, in any combination described herein.

In some variations, the amount of FEC is at least 2 wt % of the total electrolyte fluid. In some variations, the amount of FEC is at least 4 wt % of the total electrolyte fluid. In some variations, the amount of FEC is at least 6 wt % of the total electrolyte fluid. In some variations, the amount of FEC is at least 8 wt % of the total electrolyte fluid. In some variations, the amount of FEC is less than or equal to 10 wt % of the total electrolyte fluid. In some variations, the amount of FEC is less than or equal to 8 wt % of the total electrolyte fluid. In some variations, the amount of FEC is less than or equal to 6 wt % of the total electrolyte fluid. In some variations, the amount of FEC is less than or equal to 4 wt % of the total electrolyte fluid.

The amount of FEC can be selected from the lower boundary, higher boundary, or combination of both lower and higher boundary, in any combination described herein.

In some variations, the amount of PS is at least 0.5 wt % of the total electrolyte fluid. In some variations, the amount of PS is at least 1.0 wt % of the total electrolyte fluid. In some variations, the amount of PS is at least 1.5 wt % of the total electrolyte fluid. In some variations, the amount of PS is at least 2.0 wt % of the total electrolyte fluid. In some variations, the amount of PS is at least 2.5 wt % of the total electrolyte fluid. In some variations, the amount of PS is at least 3.0 wt % of the total electrolyte fluid. In some variations, the amount of PS is at least 3.5 wt % of the total electrolyte fluid. In some variations, the amount of PS is at least 4.0 wt % of the total electrolyte fluid. In some variations, the amount of PS is at least 4.5 wt % of the total electrolyte fluid. In some variations, the amount of PS is at least 5.0 wt % of the total electrolyte fluid.

In some variations, the amount of PS is less than or equal to 6.0 wt % of the total electrolyte fluid. In some variations, the amount of PS is less than or equal to 5.5 wt % of the total electrolyte fluid. In some variations, the amount of PS is less than or equal to 5.0 wt % of the total electrolyte fluid. In some variations, the amount of PS is less than or equal to 4.5 wt % of the total electrolyte fluid. In some variations, the amount of PS is less than or equal to 4.0 wt % of the total electrolyte fluid. In some variations, the amount of PS is less than or equal to 3.5 wt % of the total electrolyte fluid. In some variations, the amount of PS is less than or equal to 3.0 wt % of the total electrolyte fluid. In some variations, the amount of PS is less than or equal to 2.5 wt % of the total electrolyte fluid. In some variations, the amount of PS is less than or equal to 2.0 wt % of the total electrolyte fluid. In some variations, the amount of PS is less than or equal to 1.5 wt % of the total electrolyte fluid. In some variations, the amount of PS is less than or equal to 1.0 wt % of the total electrolyte fluid.

The amount of PS can be selected from the lower boundary, higher boundary, or combination of both lower and higher boundary, in any combination described herein.

In some variations, the amount of SN is at least 0.5 wt % of the total electrolyte fluid. In some variations, the amount of SN is at least 1.0 wt % of the total electrolyte fluid. In some variations, the amount of SN is at least 1.5 wt % of the total electrolyte fluid. In some variations, the amount of SN is at least 2.0 wt % of the total electrolyte fluid. In some variations, the amount of SN is at least 2.5 wt % of the total electrolyte fluid. In some variations, the amount of SN is at least 3.0 wt % of the total electrolyte fluid. In some variations, the amount of SN is at least 3.5 wt % of the total electrolyte fluid. In some variations, the amount of SN is at least 4.0 wt % of the total electrolyte fluid. In some variations, the amount of SN is at least 4.5 wt % of the total electrolyte fluid. In some variations, the amount of SN is at least 5.0 wt % of the total electrolyte fluid.

In some variations, the amount of SN is less than or equal to 6.0 wt % of the total electrolyte fluid. In some variations, the amount of SN is less than or equal to 5.5 wt % of the total electrolyte fluid. In some variations, the amount of SN is less than or equal to 5.0 wt % of the total electrolyte fluid. In some variations, the amount of SN is less than or equal to 4.5 wt % of the total electrolyte fluid. In some variations, the amount of SN is less than or equal to 4.0 wt % of the total electrolyte fluid. In some variations, the amount of SN is less than or equal to 3.5 wt % of the total electrolyte fluid. In some variations, the amount of SN is less than or equal to 3.0 wt % of the total electrolyte fluid. In some variations, the amount of SN is less than or equal to 2.5 wt % of the total electrolyte fluid. In some variations, the amount of SN is less than or equal to 2.0 wt % of the total electrolyte fluid. In some variations, the amount of SN is less than or equal to 1.5 wt % of the total electrolyte fluid. In some variations, the amount of SN is less than or equal to 1.0 wt % of the total electrolyte fluid.

The amount of SN can be selected from the lower boundary, higher boundary, or combination of both lower and higher boundary, in any combination described herein.

In some variations, the amount of HTCN is at least 0.01 wt % of the total electrolyte fluid. In some variations, the amount of HTCN is at least 0.1 wt % of the total electrolyte fluid. In some variations, the amount of HTCN is at least 0.5 wt % of the total electrolyte fluid. In some variations, the amount of HTCN is at least 1.0 wt % of the total electrolyte fluid. In some variations, the amount of HTCN is at least 1.5 wt % of the total electrolyte fluid. In some variations, the amount of HTCN is at least 2.0 wt % of the total electrolyte fluid. In some variations, the amount of HTCN is at least 2.5 wt % of the total electrolyte fluid. In some variations, the amount of HTCN is at least 3.0 wt % of the total electrolyte fluid. In some variations, the amount of HTCN is at least 3.5 wt % of the total electrolyte fluid. In some variations, the amount of HTCN is at least 4.0 wt % of the total electrolyte fluid. In some variations, the amount of HTCN is at least 4.5 wt % of the total electrolyte fluid. In some variations, the amount of HTCN is at least 5.0 wt % of the total electrolyte fluid. In some variations, the amount of HTCN is at least 5.5 wt % of the total electrolyte fluid.

In some variations, the amount of HTCN is less than or equal to 6.0 wt % of the total electrolyte fluid. In some variations, the amount of HTCN is less than or equal to 5.5 wt % of the total electrolyte fluid. In some variations, the amount of HTCN is less than or equal to 5.0 wt % of the total electrolyte fluid. In some variations, the amount of HTCN is less than or equal to 4.5 wt % of the total electrolyte fluid. In some variations, the amount of HTCN is less than or equal to 4.0 wt % of the total electrolyte fluid. In some variations, the amount of HTCN is less than or equal to 3.5 wt % of the total electrolyte fluid. In some variations, the amount of HTCN is less than or equal to 3.0 wt % of the total electrolyte fluid. In some variations, the amount of HTCN is less than or equal to 2.5 wt % of the total electrolyte fluid. In some variations, the amount of HTCN is less than or equal to 2.0 wt % of the total electrolyte fluid. In some variations, the amount of HTCN is less than or equal to 1.5 wt % of the total electrolyte fluid. In some variations, the amount of HTCN is less than or equal to 1.0 wt % of the total electrolyte fluid.

The amount of HTCN can be selected from the lower boundary, higher boundary, or combination of both lower and higher boundary, in any combination described herein.

In some variations, the amount of LiI is at least 0.05 wt % of the total electrolyte fluid. In some variations, the amount of LiI is at least 0.06 wt % of the total electrolyte fluid. In some variations, the amount of LiI is at least 0.07 wt % of the total electrolyte fluid. In some variations, the amount of LiI is at least 0.08 wt % of the total electrolyte fluid. In some variations, the amount of LiI is at least 0.09 wt % of the total electrolyte fluid. In some variations, the amount of LiI is at least 0.10 wt % of the total electrolyte fluid. In some variations, the amount of LiI is at least 0.20 wt % of the total electrolyte fluid. In some variations, the amount of LiI is at least 0.30 wt % of the total electrolyte fluid. In some variations, the amount of LiI is at least 0.40 wt % of the total electrolyte fluid.

In some variations, the amount of LiI is less than or equal to 0.50 wt % of the total electrolyte fluid. In some variations, the amount of LiI is less than or equal to 0.40 wt % of the total electrolyte fluid. In some variations, the amount of LiI is less than or equal to 0.30 wt % of the total electrolyte fluid. In some variations, the amount of LiI is less than or equal to 0.20 wt % of the total electrolyte fluid. In some variations, the amount of LiI is less than or equal to 0.10 wt % of the total electrolyte fluid. In some variations, the amount of LiI is less than or equal to 0.09 wt % of the total electrolyte fluid. In some variations, the amount of LiI is less than or equal to 0.08 wt % of the total electrolyte fluid. In some variations, the amount of LiI is less than or equal to 0.07 wt % of the total electrolyte fluid. In some variations, the amount of LiI is less than or equal to 0.06 wt % of the total electrolyte fluid. In some variations, the amount of LiI is less than or equal to 0.10 wt % of the total electrolyte fluid.

The amount of LiI can be selected from the lower boundary, higher boundary, or combination of both lower and higher boundary, in any combination described herein.

In some variations, the amount of Li(NO₃) is at least 0.05 wt % of the total electrolyte fluid. In some variations, the amount of Li(NO₃) is at least 0.06 wt % of the total electrolyte fluid. In some variations, the amount of Li(NO₃) is at least 0.07 wt % of the total electrolyte fluid. In some variations, the amount of Li(NO₃) is at least 0.08 wt % of the total electrolyte fluid. In some variations, the amount of Li(NO₃) is at least 0.09 wt % of the total electrolyte fluid. In some variations, the amount of Li(NO₃) is at least 0.10 wt % of the total electrolyte fluid. In some variations, the amount of Li(NO₃) is at least 0.20 wt % of the total electrolyte fluid. In some variations, the amount of Li(NO₃) is at least 0.30 wt % of the total electrolyte fluid. In some variations, the amount of Li(NO₃) is at least 0.40 wt % of the total electrolyte fluid.

In some variations, the amount of Li(NO₃) is less than or equal to 0.50 wt % of the total electrolyte fluid. In some variations, the amount of Li(NO₃) is less than or equal to 0.40 wt % of the total electrolyte fluid. In some variations, the amount of Li(NO₃) is less than or equal to 0.30 wt % of the total electrolyte fluid. In some variations, the amount of Li(NO₃) is less than or equal to 0.20 wt % of the total electrolyte fluid. In some variations, the amount of Li(NO₃) is less than or equal to 0.10 wt % of the total electrolyte fluid. In some variations, the amount of Li(NO₃) is less than or equal to 0.09 wt % of the total electrolyte fluid. In some variations, the amount of Li(NO₃) is less than or equal to 0.08 wt % of the total electrolyte fluid. In some variations, the amount of Li(NO₃) is less than or equal to 0.07 wt % of the total electrolyte fluid. In some variations, the amount of Li(NO₃) is less than or equal to 0.06 wt % of the total electrolyte fluid. In some variations, the amount of Li(NO₃) is less than or equal to 0.10 wt % of the total electrolyte fluid.

The amount of Li(NO₃) can be selected from the lower boundary, higher boundary, or combination of both lower and higher boundary, in any combination described herein.

In some variations, the amount of LiBOB is at least 0.05 wt % of the total electrolyte fluid. In some variations, the amount of LiBOB is at least 0.06 wt % of the total electrolyte fluid. In some variations, the amount of LiBOB is at least 0.07 wt % of the total electrolyte fluid. In some variations, the amount of LiBOB is at least 0.08 wt % of the total electrolyte fluid. In some variations, the amount of LiBOB is at least 0.09 wt % of the total electrolyte fluid. In some variations, the amount of LiBOB is at least 0.10 wt % of the total electrolyte fluid. In some variations, the amount of LiBOB is at least 0.20 wt % of the total electrolyte fluid. In some variations, the amount of LiBOB is at least 0.30 wt % of the total electrolyte fluid. In some variations, the amount of LiBOB is at least 0.40 wt % of the total electrolyte fluid.

In some variations, the amount of LiBOB is less than or equal to 0.50 wt % of the total electrolyte fluid. In some variations, the amount of LiBOB is less than or equal to 0.40 wt % of the total electrolyte fluid. In some variations, the amount of LiBOB is less than or equal to 0.30 wt % of the total electrolyte fluid. In some variations, the amount of LiBOB is less than or equal to 0.20 wt % of the total electrolyte fluid. In some variations, the amount of LiBOB is less than or equal to 0.10 wt % of the total electrolyte fluid. In some variations, the amount of LiBOB is less than or equal to 0.09 wt % of the total electrolyte fluid. In some variations, the amount of LiBOB is less than or equal to 0.08 wt % of the total electrolyte fluid. In some variations, the amount of LiBOB is less than or equal to 0.07 wt % of the total electrolyte fluid. In some variations, the amount of LiBOB is less than or equal to 0.06 wt % of the total electrolyte fluid. In some variations, the amount of LiBOB is less than or equal to 0.10 wt % of the total electrolyte fluid.

The amount of LiBOB can be selected from the lower boundary, higher boundary, or combination of both lower and higher boundary, in any combination described herein.

### EXAMPLES

The Examples are provided for illustration purposes only. The examples are not intended to constrain any embodiment disclosed herein to any application or theory of operation.

### Example 1

NMR of the neat DFB provides support for DFB providing lithium solvation.

Two DFB based formulations, Sample 1 and Sample 2, were measured via NMR. The NMR spectra confirmed the presence of dissociated lithium ions within the DFB in both Samples 1 and 2.

The fastest lithium-ion self-diffusion occurs when compared with other baseline electrolytes.

TABLE 1

| | Sample | | | | |
|---|---|---|---|---|---|
| | Components | | FSI- | Solvent | Li⁺ |
| | (NMR | Li⁺ Diffusion | Diffusion | Diffusion | Transference |
| Sample | Determined) | (×10⁻¹¹ m²s⁻¹) | (×10⁻¹¹ m²s⁻¹) | (×10⁻¹¹ m²s⁻¹) | Number |
| 1 | 0.4% LiFSI + | 117.6 | 119.2 | 246.9 | 0.497 |
| | 99.6% DFB | | | | |
| 2 | 0.5% LiFSI + | 117.7 | 117.0 | 247.3 | 0.501 |
| | 99.5% DFB | | | | |
| 3 | 2.5% LiFSI + | 88.0 | 91.7 | 224.4 | 0.490 |
| | 97.5% DFB | | | | |
| 4 | 2.5% LiFSI + | 42.0 | 42.5 | 87.1 | 0.497 |
| | 97.5% DFE | | | | |
| 5 | 5.1% LiFSI + | 33.8 | 34.1 | 73.3 | 0.498 |
| | 94.9% DFE | | | | |
| 6 | 10.4% LiFSI + | 22.7 | 22.5 | 52.8 | 0.502 |
| | 89.6% DFE | | | | |
| 7 | 15.8% LiFSI + | 15.7 | 15.0 | 38.0 | 0.511 |
| | 84.2% DFE | | | | |
| 8 | 30% LiFSI + | 1.80 | 2.26 | 3.00 | 0.443 |
| | 70% F4DEE | | | | |
| 9 | 2.7% LiFSI + | 19.6 | 19.6 | 32.0 | 0.459 |
| | 97.3% F4DEE | | | | |

### Example 2

The compounds of Table 2 show further examples of the compounds of Formula (I). The structures of the compounds in Table 2 were confirmed by NMR to be greater than 99% pure. Capacity for salt solvation was measured to be less than 5 mol %, and diffusion coefficients were measured for salt and solvent components.

TABLE 2

| | | Li(×10⁻¹¹ | FSI(×10⁻¹¹ | Solvent (×10⁻¹¹ | Concentration |
|---|---|---|---|---|---|
| Chemical | Abb'n | m²s⁻¹) | m²s⁻¹) | m²s⁻¹) | (mol %) |
| 2,3-difluorobutane | DFB | 88.00 | 91.00 | 224.00 | 2.5 |
| 1,2-difluorohexane | DFH | 35.90 | 39.30 | 121.50 | 3.4 |
| 1,2- | DFCH | 39.40 | 39.80 | Solid at R.T. | 2.5 |
| difluorocyclohexane | @50° C. | | | | |
| 1,2,6,7- | TFG | | | | |
| tetrafluoroheptane | | | | | |
| 1,2,7,8-tetrafluoro- | TFO | 8.68 | 9.86 | 15.88 | 2.6 |
| octane | | | | | |

In Table 2, the concentration refers to the maximum concentration of the salt that could be dissolved into the solvent. The Li, bis(fluorosulfonyl)imide (FSI), and solvent refer to diffusion coefficients (×10⁻¹¹ m²s⁻¹) of each species. In general, species with higher diffusion coefficients showed less dendritic formation, and flatter and more uniform Li deposition. The resulting electrolyte had higher conductivity.

The solvent of one of Formulae (I), (II), (IV), (V), (VI), (VII), (VIII), or (IX) can be used in other contexts. The electrolyte fluid can be used in a non-lithium battery substituting any non-lithium battery for a lithium battery in any variation, as described herein. Examples of such non-lithium batteries include any such battery that can use non-lithium species as the electrochemically active species. Non-limiting examples of such electrochemically ac include sodium batteries and zinc batteries. Likewise, the electrolyte fluid can be used as a co-solvent for any battery in any variation, as described herein. In some variations, the electrolyte fluid as described herein in any variation, or solvent of Formulae (I), (II), (IV), (V), (VI), (VII), (VIII), or (IX), can be used in a capacitor, flow battery, or fuel cell.

The electrolyte fluids described herein can be valuable in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A battery cell comprising:
a cathode comprising a cathode active material disposed on a cathode current collector;
an anode comprising an anode active material disposed on an anode current collector, the anode oriented towards the cathode such that the anode active material faces the cathode active material;
a separator disposed between the cathode active material and the anode active material; and
an electrolyte fluid comprising a solvent compound having the structure according to Formula (I): 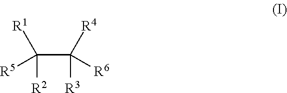
wherein
R¹ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R² is hydrogen or halo;
R³ is halo;
R⁴ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁵ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁶ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
or optionally R¹ and R⁴ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
or optionally R⁵ and R⁶ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
wherein if R² is hydrogen, then
R⁵ is halo, halo-substituted alkyl, non-oxygen substituted halo-substituted alkyl, halo-substituted non-oxygen heteroalkyl, non-oxygen substituted halo-substituted non-oxygen heteroalkyl, halo-substituted cycloalkyl, non-oxygen substituted halo-substituted cycloalkyl, or non-oxygen substituted non-oxygen heterocycloalkyl; or R⁵ and R⁶ together with the carbon atoms to which they are attached form a halo-substituted cycloalkyl, non-oxygen substituted halo-substituted cycloalkyl, halo-substituted non-oxygen heterocycloalkyl, non-oxygen substituted halo-substituted non-oxygen heterocycloalkyl; and
the structure of Formula (I) has from 4 to 11 carbon atoms.

2. The battery cell of claim 1, wherein one or more of R¹, R⁴, R⁵, and R⁶ is a halo-substituted alkyl.

3. The battery cell of claim 1, wherein the halo-substitutions are fluoro-substitutions.

4. The battery cell of claim 1, wherein the structure of Formula (I) has from 4 to 9 carbon atoms.

5. The battery cell of claim 1, wherein:
R¹ is selected from hydrogen, methyl, halo-substituted methyl, ethyl, halo-substituted ethyl, n-propyl, halo-substituted n-propyl, isopropyl, halo-substituted isopropyl, and halo;
R² and R³ are each independently halo;
R⁴ is selected from hydrogen, methyl, halo-substituted methyl, ethyl, halo-substituted ethyl, n-propyl, halo-substituted n-propyl, isopropyl, halo-substituted isopropyl, and halo;
R⁵ is selected from hydrogen, methyl, halo-substituted methyl, ethyl, halo-substituted ethyl, n-propyl, halo-substituted n-propyl, isopropyl, halo-substituted isopropyl, and halo;
R⁶ is selected from hydrogen, methyl, halo-substituted methyl, ethyl, halo-substituted ethyl, n-propyl, halo-substituted n-propyl, isopropyl, halo-substituted isopropyl, and halo;
wherein the structure of Formula (I) has from 4 to 11 carbon atoms.

6. The battery cell of claim 5, wherein one or more of R¹, R⁴, R⁵, and R⁶ is selected from halo-substituted methyl, halo-substituted ethyl, halo-substituted n-propyl, and halo-substituted isopropyl.

7. The battery cell of claim 5, wherein the halo-substitutions are fluoro-substitutions.

8. The battery cell of claim 5, wherein the structure of Formula (I) has from 4 to 9 carbon atoms.

9. The battery cell of claim 1, wherein the solvent compound is 2,3-difluorobutane (DFB).

10. The battery cell of claim 1, wherein the solvent compound has the structure of Formula (IV): 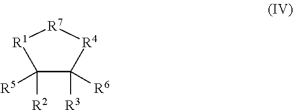
wherein
the ring including R¹—R⁷—R⁴ together with the carbon atoms to which they are attached form a C₄-C₉ cycloalkyl, halo-substituted C₄-C₉ cycloalkyl, non-oxygen substituted C₄-C₉ cycloalkyl, non-oxygen heterocycloalkyl, non-oxygen substituted non-oxygen heterocycloalkyl, non-oxygen substituted halo-substituted cycloalkyl, halo-substituted non-oxygen heterocycloalkyl, non-oxygen substituted halo-substituted non-oxygen heterocycloalkyl;
R² is hydrogen or halo;
R³ is halo;
R⁵ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁶ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
or optionally R⁵ and R⁶ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
wherein if R² is hydrogen, then
R⁵ is halo, halo-substituted alkyl, non-oxygen substituted halo-substituted alkyl, halo-substituted non-oxygen heteroalkyl, non-oxygen substituted halo-substituted non-oxygen heteroalkyl, halo-substituted cycloalkyl, non-oxygen substituted halo-substituted cycloalkyl, or non-oxygen substituted non-oxygen heterocycloalkyl; or R⁵ and R⁶ together with the carbon atoms to which they are attached form a halo-substituted cycloalkyl, non-oxygen substituted halo-substituted cycloalkyl, halo-substituted non-oxygen heterocycloalkyl, non-oxygen substituted halo-substituted non-oxygen heterocycloalkyl; and
wherein the structure of Formula (IV) has from 4 to 11 carbon atoms.

11. The battery cell of claim 10, wherein the solvent compound has the structure of Formula (V) (1,2-difluorocyclohexane (DFCH)):

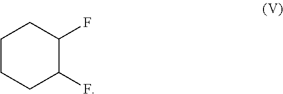

12. The battery cell of claim 10, wherein the solvent compound has the structure of Formula (VI) (1,2,4,5-tetrafluorocyclohexane (TFCH)):

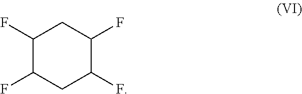

13. The battery cell of claim 10, wherein the solvent compound has the structure of Formula (VII) (1,2-difluorohexane (DFH)):

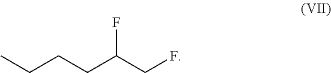

14. The battery cell of claim 10, wherein the solvent compound has the structure of Formula (VIII) (1,2,6,7-tetrafluoroheptane (TFG)):

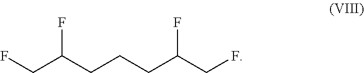 [SMILES: FCC(F)CCCC(F)CF]

15. The battery cell of claim 10, wherein the solvent compound has the structure of Formula (IX) (1,2,7,8-tetrafluoro-octane (TFO)):

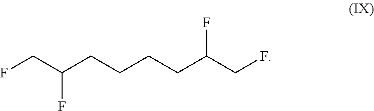 [SMILES: FCC(F)CCCCC(F)CF]

16. The battery cell of claim 1, wherein the electrolyte solvent compound is from 30-95 wt % of the electrolyte fluid.

17. The battery cell of claim 1, wherein the electrolyte fluid comprises an electrolyte salt selected from LiFSI, LiPF₆, LiBF₄, LiClO₄, LiSO₃CF₃, LiFSI, LiN(SO₂CF₃)₂, LiBC₄O₈, Li[PF₃(C₂CF₅)₃], LiC(SO₂CF₃)₃, LiDFOB, LiNO₃, LiI, LiBOB, and a combination thereof.

18. The battery cell of claim 17, wherein the salt comprises LiFSI.

19. The battery cell of claim 17, wherein the salt is from 0.1 M to 4.0 M.

20. The battery cell of claim 1, wherein the electrolyte fluid is consisting of the electrolyte solvent compound and an electrolyte salt.

21. A battery cell comprising:
a cathode comprising a cathode active material disposed on a cathode current collector;
an anode comprising an anode active material disposed on an anode current collector, the anode oriented towards the cathode such that the anode active material faces the cathode active material;
a separator disposed between the cathode active material and the anode active material; and
an electrolyte fluid comprising:
a solvent selected from propylene carbonate (PC), ethylene carbonate (EC), dimethyl carbonate (DMC), diethyl carbonate (DEC), ethyl-methyl carbonate (EMC), ethyl propionate (EP), butyl butyrate (BB), methyl acetate (MA), methyl butyrate (MB), methyl propionate (MP), propylene carbonate (PC), ethyl acetate (EA), propyl propionate (PP), butyl propionate (BP), propyl acetate (PA), butyl acetate (BA), dimethoxyethane (DME), tetrahydrofuran (THF), 1,4-dioxane (DOX), 1,3-dioxane (DOL), a hydrofluoroether, and a combination thereof; and
a cosolvent compound having the structure according to Formula (I): 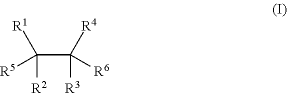
wherein
R¹ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R² is hydrogen or halo;
R³ is halo;
R⁴ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁵ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
R⁶ is selected from hydrogen, halo, alkyl, non-oxygen substituted alkyl, non-oxygen heteroalkyl, non-oxygen substituted non-oxygen heteroalkyl, halo-substituted alkyl, non-oxygen substituted halo-substituted alkyl, halo-substituted non-oxygen heteroalkyl, and non-oxygen substituted halo-substituted non-oxygen heteroalkyl;
or optionally R¹ and R⁴ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
or optionally R⁵ and R⁶ together with the carbon atoms to which they are attached form a cycloalkyl, non-oxygen substituted cycloalkyl, non-oxygen heterocycloalkyl, non-oxygen substituted non-oxygen heterocycloalkyl, halo-substituted cycloalkyl, non-oxygen substituted halo-substituted cycloalkyl, halo-substituted non-oxygen heterocycloalkyl, non-oxygen substituted halo-substituted non-oxygen heterocycloalkyl;
wherein if R² is hydrogen, then
R⁵ is halo, halo-substituted alkyl, non-oxygen substituted halo-substituted alkyl, halo-substituted non-oxygen heteroalkyl, non-oxygen substituted halo-substituted non-oxygen heteroalkyl, halo-substituted cycloalkyl, non-oxygen substituted halo-substituted cycloalkyl, or non-oxygen substituted non-oxygen heterocycloalkyl; or
R⁵ and R⁶ together with the carbon atoms to which they are attached form a halo-substituted cycloalkyl, non-oxygen substituted halo-substituted cycloalkyl, halo-substituted non-oxygen heterocycloalkyl, non-oxygen substituted halo-substituted non-oxygen heterocycloalkyl; and
and
wherein the structure of Formula (I) has from 4 to 11 carbon atoms.

22. The battery cell of claim 21, wherein the cosolvent compound is from 5-50 wt % of the electrolyte fluid.

23. The battery cell of claim 22, wherein the electrolyte fluid comprises an additive selected from lithium difluoro(oxalato)borate (LiDFOB), prop-1-ene-1, 3-sultone (PES), methylene methanedisulfonate (MMDS), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl)ether (EGPN), 1,3,6-hexanetricarbonitrile (HTCN), lithium iodide (LiI), Li(NO₃), lithium bis(oxalato)borate (LiBOB), and a combination thereof.
